(19) United States
(12) Patent Application Publication
(10) Pub. No.: US 2013/0002973 A1
(43) Pub. Date: Jan. 3, 2013

(54) STEREO IMAGING DEVICE HAVING LIQUID CRYSTAL LENS

(75) Inventor: GA-LANE CHEN, Santa Clara, CA (US)

(73) Assignee: HON HAI PRECISION INDUSTRY CO., LTD., Tu-Cheng (TW)

(21) Appl. No.: 13/209,455

(22) Filed: Aug. 15, 2011

(30) Foreign Application Priority Data
Jun. 29, 2011 (TW) 100122864

(51) Int. Cl. G02F 1/1335

(52) U.S. Cl. 349/15

(57) ABSTRACT

A stereo imaging device includes two imaging units and an image processing unit. Each of the imaging units includes an image sensor, a liquid crystal lens, and a driving unit. The liquid crystal lens includes a first electrode layer having concentric, annular electrodes, a second electrode layer and a liquid crystal layer between the first and second electrode layers. The driving unit provides voltages between each of the annular electrodes and the second electrode layer so as to create a radial gradient of the refractive indexes of the liquid crystal layer. The image sensor receives light through the liquid crystal lens to form an image. The image processing unit combines the two images formed by the image sensors to form a single stereo image, and controls the driving unit to apply varying voltages between each of the annular electrodes and the second electrode layers.

### BACKGROUND

1. Technical Field

The present disclosure relates to stereo imaging devices having a liquid crystal lens.

2. Description of Related Art

Stereo imaging devices are widely used, and the device generally includes two lens modules. The lens module is configured for directing light onto an image sensor. The lens module includes lens(es) and a lens barrel for holding the lens(es). A complicated and bulky motor is used to move the lens(es).

Therefore, a stereo imaging device which can overcome the limitations described, is needed.

### BRIEF DESCRIPTION OF THE DRAWINGS

FIG. 1 is a sectional view of a stereo imaging device including a first liquid crystal lens and a second liquid crystal lens, according to a first embodiment.

FIG. 2 is a sectional view of the first liquid crystal lens of FIG. 1.

FIG. 3 is a top view of the first liquid crystal lens of FIG. 2.

FIG. 4 is a sectional view of the second liquid crystal lens of FIG. 1.

FIG. 5 is a top view of the second liquid crystal lens of FIG. 4.

FIG. 6 is a sectional view of a stereo imaging device including two liquid crystal lenses, according to a second embodiment.

FIG. 7 is a sectional view of the liquid crystal lens of FIG. 6.

FIG. 8 is a sectional view of a stereo imaging device according to a third embodiment.

### DETAILED DESCRIPTION

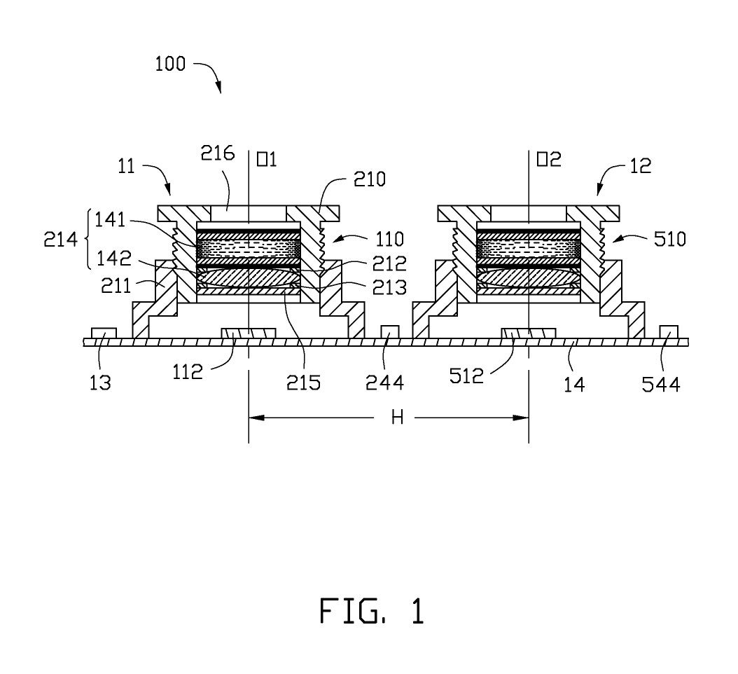

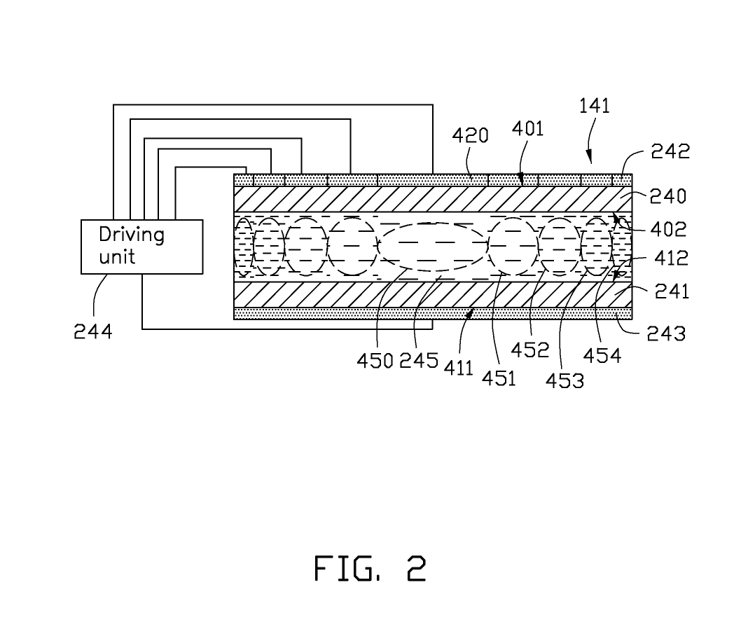

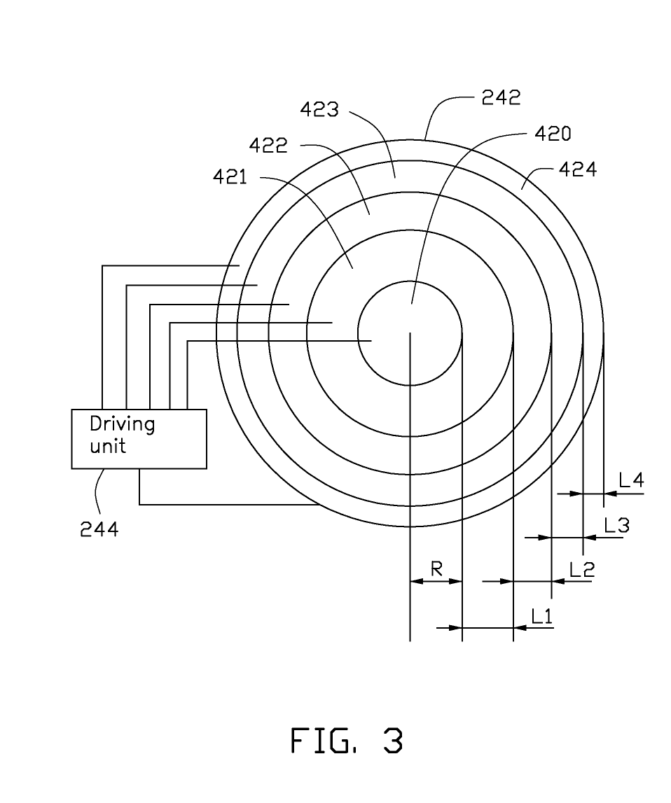

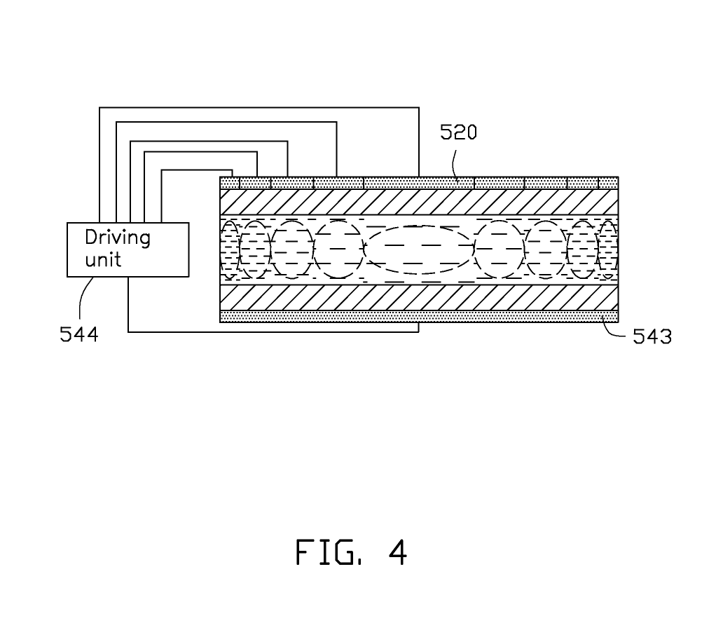

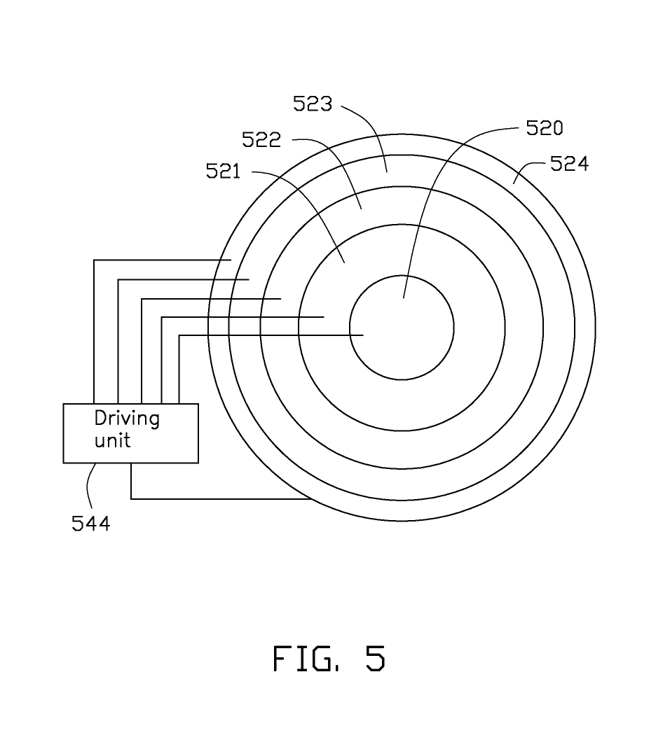

Referring to FIGS. 1-5, a stereo imaging device, according to a first embodiment, includes a first imaging unit 11, a second imaging unit 12, an image processing unit 13 and a circuit board 14. The first imaging unit 11 is separate from the second imaging unit 12. The image processing unit 13 is electrically connected to the first and second imaging units 11, 12. The first imaging unit 11, the second imaging unit 12 and the image processing unit 13 are positioned on the circuit board 14.

The first imaging unit 11 includes a lens module 110 and an image sensor 112 arranged at an image side of the lens module 110. The lens module 110 includes a lens barrel 210, a lens holder 211, a first spacer 212, a second spacer 213, a lens group 214, an infrared-cut filter 215 and a driving unit 244.

The lens group 214 includes a liquid crystal lens 141 and an optical lens 142. The driving unit 244 is electrically connected to the liquid crystal lens 141. The optical lens 142 is made of plastic or glass. The lens barrel 210 is threadedly engaged with the lens holder 211. An incident light entry hole (light incident through hole 216) is defined at top of the lens barrel 210.

The liquid crystal lens 141, the first spacer 212, the optical lens 142, the second spacer 213 and the infrared-cut filter 215 are arranged in the lens barrel 210 in order from an object side to the image side of the lens module 110.

The liquid crystal lens 141 includes a first base plate 240, a second base plate 241, a first electrode layer 242, a second electrode layer 243, and a liquid crystal layer 245. The liquid crystal layer 245 fills the space between the first base plate 240 and the second base plate 241. The first base plate 240 is substantially parallel to the second base plate 241. The material of the first base plate 240 and the second base plate 241 is a light-pervious material, e.g. glass and light-pervious plastic. The thickness of the first base plate 240 and of the second base plate 241 is in the range from about 0.1 millimeter (mm) to about 0.5 mm, and from about 0.2 mm to 0.4 mm is preferred.

The first base plate 240 includes an outer surface 401 and an inner surface 402 at opposite sides of the first base plate 240. The outer surface 401 faces away from the liquid crystal layer 245. The first electrode layer 242 is arranged on the outer surface 401 of the first base plate 240. The first electrode layer 242 includes a round electrode 420, and four annular electrodes 421, 422, 423, 424 with a same center O. The round electrode 420 and the four annular electrodes 421, 422, 423, 424 are concentrically aligned in the order as written, from the center O outwards. In practice, the total number of the round electrode 420 plus the annular electrodes 421, 422, 423, 424 may be more than 5. Preferably, the total number of the round electrode 420 plus the annular electrodes 421, 422, 423, 424 is in the range from 5 to 20, and ideally in the range from 7 to 15 so that the liquid crystal lens 141 can have the properties of both good optical performance and ease of manufacture. The thickness of the first electrode layer 240 may be in the range from 50 nanometers to 500 nanometers, and preferably in the range from 100 nanometers to 300 nanometers.

The round electrode 420 has a radius R. The annular electrodes 421, 422, 423, 424 have the widths L1, L2, L3, L4, respectively. Preferably, the radius R and the widths L1, L2, L3, L4 satisfy R>L1>L2>L3>L4. In the exemplary embodiment, each two adjacent electrodes of the round electrodes 420 and the annular electrodes 421, 422, 423, 424 substantially abut each other and are electrically insulated from one another by insulating glue. In alternative embodiments, each two adjacent electrodes of the round electrodes 420 and the annular electrodes 421, 422, 423, 424 may be spaced very close together.

The second base plate 241 includes an outer surface 411 and an inner surface 412 at opposite sides of the second base plate 241. The outer surface 411 faces away from the liquid crystal layer 245. The second electrode layer 243 is arranged on the outer surface 411 of the second base plate 241. The second electrode layer 243 is a planar electrode. In use, voltages will be applied between the round electrode 420 and the second electrode layer 243, between the annular electrode 421 and the second electrode layer 243, between the annular electrode 422 and the second electrode layer 243, between the annular electrode 423 and the second electrode layer 243, and between the annular electrode 424 and the second electrode layer 243.

Both of the first electrode layer 242 and the second electrode layer 243 are comprised of a carbon nanotube material. The carbon nanotube material can be selected from a group consisting of single-walled carbon nanotube, multi-walled carbon nanotube, single-walled carbon nanotube bundles, multi-walled carbon nanotube bundles and super-aligned multi-walled carbon nanotube yarns. The first electrode layer 242 is formed on the outer surface 401 of the first base plate 240 by, but not limited to, a photo-masking process. In alternative embodiments, the material of the first electrode layer 242 and the second electrode layer 243 is indium-tin oxide.

The liquid crystal layer 245 is divided into five regions, i.e. a round region 450, a first annular region 451, a second annular region 452, a third annular region 453, and a fourth annular region 454. The round region 450, the first annular region 451, the second annular region 452, the third annular region 453, and the fourth annular region 454 are located between the first electrode layer 242 and the second electrode layer 243, and correspond to the round electrode 420, and respectively to the annular electrodes 421, 422, 423 424. In the exemplary embodiment, the densities of the liquid crystal in the round region 450, the first annular region 451, the second annular region 452, the third annular region 453, and the fourth annular region 454, increase in the order as written. It is to be understood that the densities of the liquid crystal in the round region 450, the first annular region 451, the second annular region 452, the third annular region 453, and the fourth annular region 454, decrease in the order as written.

The driving unit 244 is electrically connected to the first electrode layer 242, the second electrode layer 243 and the image processing unit 13. The driving voltage unit 16 is configured to provide voltages between the round electrode 420 and the second electrode layer 243, between the annular electrode 421 and the second electrode layer 243, between the annular electrode 422 and the second electrode layer 243, between the annular electrode 423 and the second electrode layer 243, and between the annular electrode 424 and the second electrode layer 243.

In operation, the driving unit 244 applies voltages between the first electrode layer 242 and the second electrode layer 243. The voltages between the round electrode 420 and the second electrode layer 243, between the annular electrode 421 and the second electrode layer 243, between the annular electrode 422 and the second electrode layer 243, between the annular electrode 423 and the second electrode layer 243, and between the annular electrode 424 and the second electrode layer 243, are controlled separately by the driving unit 244. All of the voltages are larger than the threshold voltage of the liquid crystal layer 245, so the liquid crystal molecules of the liquid crystal layer 245 in the round region 450, the first annular region 451, the second annular region 452, the third annular region 453, and the fourth region 454 can turn to form an angle between the liquid crystal molecules and either the first base plate 240 or the second base plate 241. If the voltages are controlled appropriately, the angles between the liquid crystal molecules and either the first base plate 240 or the second base plate 241 may be distributed in a radial gradient from the center of the round electrode 420.

The refractive index of the liquid crystal layer 245 increases as the angle included by the lengthwise orientation of the liquid crystal molecules of the liquid crystal layer 245 and the transmission direction of the light passing through the liquid crystal layer 245 increases. In the exemplary embodiment, the transmission direction of the light passing through the liquid crystal layer 245 is perpendicular to either the first base plate 240 or the second base plate 241. When the lengthwise orientation of the liquid crystal molecules of the liquid crystal layer 245 is parallel with the transmission direction of the light passing through the liquid crystal layer 245, the refractive index of the liquid crystal layer 245 has its minimum value. When the lengthwise orientation of the liquid crystal molecules of the liquid crystal layer 245 is perpendicular to the transmission direction of the light passing through the liquid crystal layer 245, the refractive index of the liquid crystal layer 245 has its maximum value. Thus, the refractive index of the liquid crystal layer can be controlled to decrease or to increase in a radial gradient from the center to the periphery of the liquid crystal layer.

Therefore, applying the proper voltages between the round electrode 420 and the second electrode layer 243, between the annular electrode 421 and the second electrode layer 243, between the annular electrode 422 and the second electrode layer 243, between the annular electrode 423 and the second electrode layer 243, and between the annular electrode 424 and the second electrode layer 243 may make the angles included by the lengthwise orientation of the liquid crystal molecules and the transmission direction of the light passing through the liquid crystal layer 245 an even distribution across a radial gradient from the round region 450 to the fourth annular region 454. Thus the refractive indexes of the round region 450, the first annular region 451, the second annular region 452, the third annular region 453 and the fourth annular region 454 are found to be distributed in a radial gradient in the order as written, thus the liquid crystal lens 141 forms a gradient-index lens.

The radial gradient of the refractive indexes can vary by varying the refractive indexes of the liquid crystal layer 245. The focal length of the liquid crystal lens 141 is determined by the radial gradient of the refractive indexes. Therefore, the focal length can be changed by controlling the voltages between the round electrode 420 and the second electrode layer 243, between the annular electrode 421 and the second electrode layer 243, between the annular electrode 422 and the second electrode layer 243, between the annular electrode 423 and the second electrode layer 243, and between the annular electrode 424 and the second electrode layer 243.

The lens holder 211 and the image sensor 112 are positioned on the circuit board 14. The lens holder 211 and the circuit board 14 cooperatively seal the image sensor 112. The image sensor 112 is electrically connected to the circuit board 14. The image sensor 112 is configured to receive light through the light incident through hole 216 and the lens group 214 to form images. The image sensor 112 may be a charge-coupled device or a complementary metal oxide semiconductor and may have 5 mega pixels, 8 mega pixels, 12 mega pixels, 16 mega pixels, 20 mega pixels, or 100 mega pixels. The individual pixel size in the image sensor 112 may be 1.75, 1.4, 1.1, 0.9, 0.8 or 0.6 microns. If the complementary metal oxide semiconductor is used for the image sensor 112, the image sensor 112 can use electrical power more efficiently.

The configuration(s) and structure(s) of the second imaging unit 12 are substantially the same as those of the first imaging unit 11. Referring to FIGS. 1 and 4-5, the second imaging unit 12 includes a lens module 510, an image sensor 512, a driving unit 544, a second electrode layer 543, a round electrode 520, and four annular electrodes 521, 522, 523, 524.

A distance H between the optical axis O1 of the lens module 110 and the optical axis O2 of the lens module 510 is in the range from about 25 to about 40 millimeters. In this embodiment, H=32.5 millimeters.

The image processing unit 13, and the driving units 244, 544 are positioned on the circuit board 14 and electrically connected to the circuit board 14. The image processing unit 13 is also electrically connected to the image sensors 112, 512. The image processing unit 13 is configured to receive and combine the two images respectively formed by the image sensors 112, 512 to form a single stereo image, and to control the driving units 244, 544 to apply voltages between the round electrodes 420, 520 and the second electrode layers 243, 543, and between the annular electrodes 421, 521 and the second electrode layers 243, 543, and between the annular electrodes 422, 522 and the second electrode layers 243, 543, and between the annular electrodes 423, 523 and the second electrode layers 243, 543, and between the annular electrodes 424, 524 and the second electrode layers 243, 543.

The creation of the stereo image may be achieved by any known method or technology in the art. The format of the stereo image which is outputted from the image processing unit 13 may be a side-by-side format or a left-to-right format.

In the present embodiment, the focal length of the liquid crystal lens 141 is variable, so that there is no need for a motor to physically move the lenses, and therefore the size of the lens modules 110, 510 is reduced. This further minimizes the stereo imaging device 100. Additionally, the nanoscale size and the electrical and optical conductivity of the carbon nanotube allows a liquid crystal lens employing this material for the electrodes to be used in miniature optic-electronic products, for example a camera of a mobile phone. The stereo imaging device 100 which is so equipped can be used to take video with high frame rate, perhaps from about 10 to about 90 fps, and preferably about 20 to about 40 fps.

The round electrode 420 can be replaced by an annular electrode. In this situation, the liquid crystal lens 141 can form a gradient-index lens if the proper voltages are applied to the liquid crystal molecules between the annular electrodes of the first electrode layer and the second electrode layer to make the refractive indexes of the liquid crystal layer 245 a substantially smooth radial gradient. The two driving units 244, 544 can be integrated into one unit to control the liquid crystal lenses.

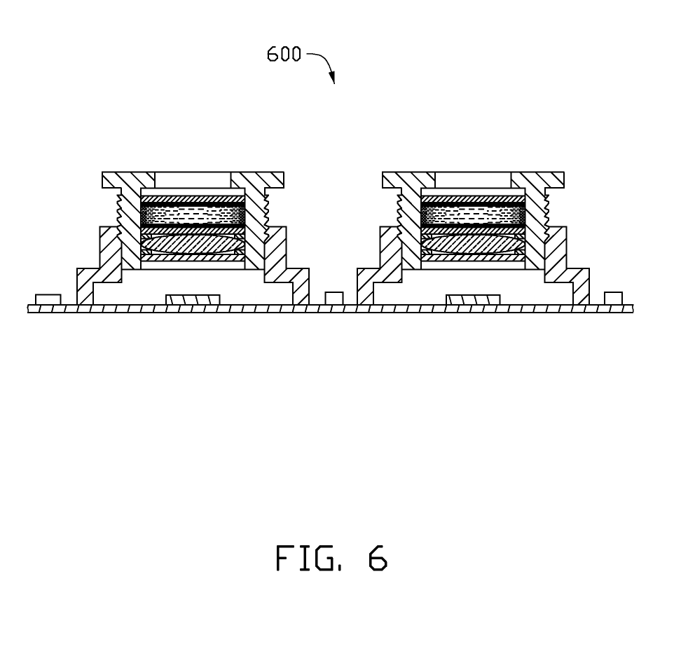

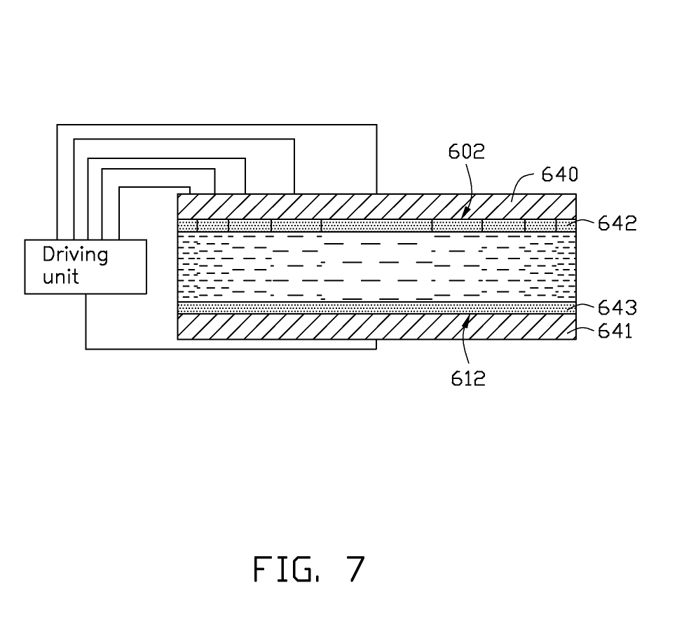

Referring to FIGS. 6 and 7, a stereo imaging device 600, according to a second embodiment, is shown. The differences between the stereo imaging device 600 and the stereo imaging device 100 are that a first electrode layer 642 is arranged on an inner surface 602 of a first base plate 640, and a second electrode layer 643 is arranged on an inner surface 612 of a second base plate 641.

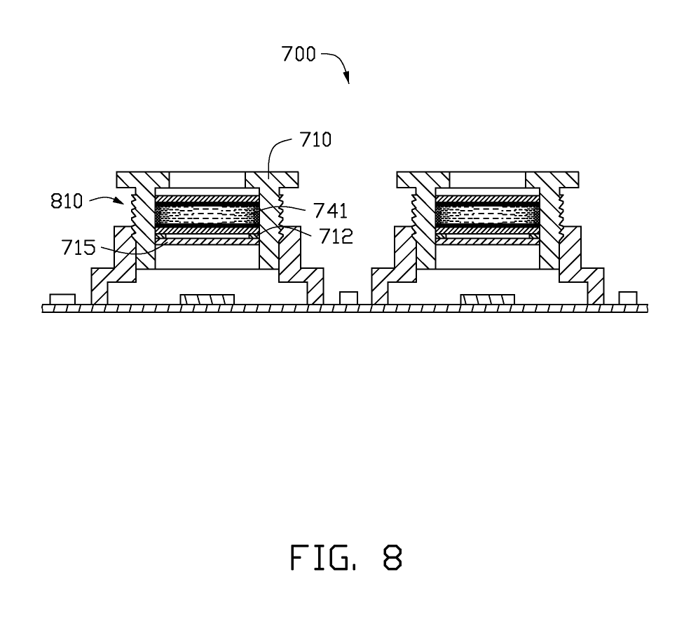

Referring to FIG. 8, a stereo imaging device 700, according to a third embodiment, is shown. The differences between the stereo imaging device 700 and the stereo imaging device 100 are that the lens group (not labeled) only includes a liquid crystal lens 741 in a lens barrel 710, and the second spacer is omitted. The liquid crystal lens 741, a first spacer 712 and an infrared-cut filter are arranged in that order from the object side of a lens module 810 to the image side.

In alternative embodiments, the first electrode layer may be arranged on the inner surface of the first base plate and the second electrode layer may be arranged on the outer surface of the second base plate. The first electrode layer may be arranged on the outer surface of the first base plate and the second electrode layer may be arranged on the inner surface of the second base plate.

Although numerous characteristics and advantages of the present embodiments have been set forth in the foregoing description, together with details of the structures and functions of the embodiments, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A stereo imaging device, comprising:
two imaging units being separate from each other, each imaging unit comprising a lens module and an image sensor positioned at an image side of the lens module, the lens module comprising a lens barrel, a liquid crystal lens received in the lens barrel and a driving unit electrically connected to the liquid crystal lens, the liquid crystal lens comprising a first light-pervious plate, a second light-pervious plate opposite to the first light-pervious plate, a first electrode layer arranged on the first light-pervious plate, a second electrode layer arranged on the second light-pervious plate and a liquid crystal layer sandwiched between the first light-pervious plate and the second light-pervious plate, the first electrode layer comprising a plurality of concentric, annular electrodes arranged on the first light-pervious plate, the liquid crystal layer comprising a plurality of annular regions spatially corresponding to the respective annular electrodes, a density of liquid crystal in the annular regions of the liquid crystal layer being different from each other, the driving unit configured to provide voltages between each of the annular electrodes and the second electrode layer for creating a gradient distribution of refractive index of the liquid crystal layer in radial directions of the liquid crystal lens, the image sensor configured to receive light from the liquid crystal lens to form an image; and
an image processing unit configured to receive and combine two images respectively formed by the image sensors to form a stereo image, and to control the driving unit to apply voltages between each of the annular electrodes and the second electrode layers.

2. The stereo imaging device of claim 1, wherein the first electrode layer further comprises a round electrode concentric with the plurality of annular electrodes, the diameter of the round electrode is smaller than the interior diameter of the innermost annular electrode.

3. The stereo imaging device of claim 1, wherein a width of the annular electrodes decreases in the radial directions of the liquid crystal lens from a center to a periphery of the first electrode layer.

4. The stereo imaging device as claimed in claim 1, wherein a density of the liquid crystal in the annular regions gradually increases or decreases in the radial directions of the liquid crystal lens from a center to a periphery of the liquid crystal layer.

5. The stereo imaging device of claim 1, wherein the refractive index of the liquid crystal layer decreases in radial gradient from a center to a periphery of the liquid crystal layer.

6. The stereo imaging device of claim 1, wherein the refractive index of the liquid crystal layer increases in radial gradient from a center to a periphery of the liquid crystal layer.

7. The stereo imaging device of claim 1, wherein the optical axes of the lens modules are spaced apart with a distance in a range from about 25 to about 40 millimeters.

8. The stereo imaging device of claim 1, wherein the lens module further comprises an infrared-cut filter and a spacer received in the lens barrel, the liquid crystal, the spacer and the infrared-cut filter arranged in order from an object side to the image side of the lens module.

9. The stereo imaging device of claim 1, wherein the lens module further comprises a first spacer, an optical lens, a second spacer and an infrared-cut filter received in the lens barrel, the liquid crystal, the first spacer, the optical lens, the second spacer and the infrared-cut filter arranged in order from an object side to the image side of the lens module.

10. The stereo imaging device of claim 1, further comprising a circuit board and the lens module further comprising a lens holder threadedly engaged with the lens barrel, the image sensor and the lens holder positioned on the circuit board, the circuit board and the lens holder cooperatively sealing the image sensor.

11. The stereo imaging device of claim 1, wherein the first light-pervious plate comprises an outer surface and an inner surface at opposite sides of the first light-pervious plate, the outer surface of the first light-pervious plate facing away from the second light-pervious plate, the first electrode layer arranged on the outer surface of the first light-pervious plate.

12. The stereo imaging device of claim 11, wherein the second light-pervious plate comprises an outer surface and an inner surface at opposite sides of the second light-pervious plate, the outer surface of the second light-pervious plate facing away from the first light-pervious plate, the second electrode layer arranged on the outer surface of the second light-pervious plate.

13. The stereo imaging device of claim 1, wherein the first light-pervious plate comprises an outer surface and an inner surface at opposite sides of the first light-pervious plate, the outer surface of the first light-pervious plate facing away from the second light-pervious plate, the first electrode layer arranged on the inner surface of the first light-pervious plate.

14. The stereo imaging device of claim 13, wherein the second light-pervious plate comprises an outer surface and an inner surface at opposite sides of the second light-pervious plate, the outer surface of the second light-pervious plate facing away from the first light-pervious plate, the second electrode layer arranged on the inner surface of the second light-pervious plate.
